(19) United States
(12) Patent Application Publication
(10) Pub. No.: US 2013/0042178 A1
(43) Pub. Date: Feb. 14, 2013

(54) DISPLAY CONTROLLING APPARATUS, CONTROL METHOD THEREOF AND RECORDING MEDIUM

(71) Applicant: Yasushi Kachi, Kawasaki-shi (JP)

(72) Inventor: Yasushi Kachi, Kawasaki-shi (JP)

(73) Assignee: CANON KABUSHIKI KAISHA, Tokyo (JP)

(21) Appl. No.: 13/560,376

(22) Filed: Jul. 27, 2012

(30) Foreign Application Priority Data
Aug. 12, 2011 (JP) 2011-177250
Jul. 11, 2012 (JP) 2012-155883

(51) Int. Cl. G06F 3/048

(52) U.S. Cl. 715/716

(57) ABSTRACT

A list of moving image data is displayed using preset representative images. When a predetermined person is selected in response to a user operation and a frame containing the predetermined person exists in moving image data, the list is displayed using a representative image generated from the frame containing the predetermined person, in place of the preset representative image.

### BACKGROUND OF THE INVENTION

1. Field of the Invention

The present invention relates to a display controlling apparatus, control method thereof, and recording medium and, particularly to a moving image data list display technique using representative images.

2. Description of the Related Art

Conventionally, for example, management software for managing moving image data displays a list using representative images (thumbnail images) each generated from one frame contained in moving image data, as disclosed in Japanese Patent Laid-Open No. 2009-88961. The management software allows the user to confirm the contents of moving image data without playing back the moving image data. The user can easily detect moving image data of his choice.

However, an image displayed as a representative image is generated from a frame selected based on a predetermined rule, such as the first frame. The user cannot always understand the contents of moving image data. Especially, a plurality of moving image data captured under the same image capture conditions have similar representative images. It is therefore difficult to discriminate the contents of the respective moving image data from only their representative images. For example, when the user searches a plurality of moving image data captured under the same image capture conditions for moving image data containing a scene which captures a specific person, he needs to play back and confirm moving image data whose representative image does not contain the person.

### SUMMARY OF THE INVENTION

The present invention has been made to solve the conventional problems. The present invention provides a display controlling apparatus which displays a list from which the user can easily specify moving image data capturing a person of the user's choice, a control method thereof, and a recording medium.

The present invention in its first aspect provides a display controlling apparatus comprising: an obtaining unit configured to obtain moving image data; a display controlling unit configured to display, on a screen, a representative image set in advance for moving image data obtained by the obtaining unit; a determination unit configured to determine whether a frame satisfying predetermined conditions exists in the moving image data; and a selection unit configured to select at least one of the predetermined conditions in response to a user operation, wherein when the selection unit selects the predetermined condition, the display controlling unit displays a representative image generated from a frame satisfying the selected predetermined condition, in place of the representative image set in advance for the moving image data.

Further features of the present invention will become apparent from the following description of exemplary embodiments (with reference to the attached drawings).

### BRIEF DESCRIPTION OF THE DRAWINGS

FIG. 1 is a block diagram showing the functional arrangement of a digital camera 100 according to an embodiment of the present invention;

FIG. 2 is a block diagram showing the functional arrangement of a camera unit 104 according to the embodiment of the present invention;

FIG. 3 is a flowchart showing representative image information generation processing according to the embodiment of the present invention;

FIG. 4 is a view for explaining person detection information according to the embodiment of the present invention;

FIG. 5 is a table exemplifying representative image information according to the embodiment of the present invention;

FIG. 6 is a flowchart showing moving image list display processing according to the embodiment of the present invention; and

FIGS. 7A and 7B are views each exemplifying a moving image data list display screen according to the embodiment of the present invention.

### DESCRIPTION OF THE EMBODIMENTS

An exemplary embodiment of the present invention will now be described in detail with reference to the accompanying drawings. In the following embodiment, the present invention is applied to a digital camera capable of capturing a moving image, which is an example of a display controlling apparatus. However, the present invention is applicable to an arbitrary device capable of displaying a list of recorded moving image data.

### <Functional Arrangement of Digital Camera 100>

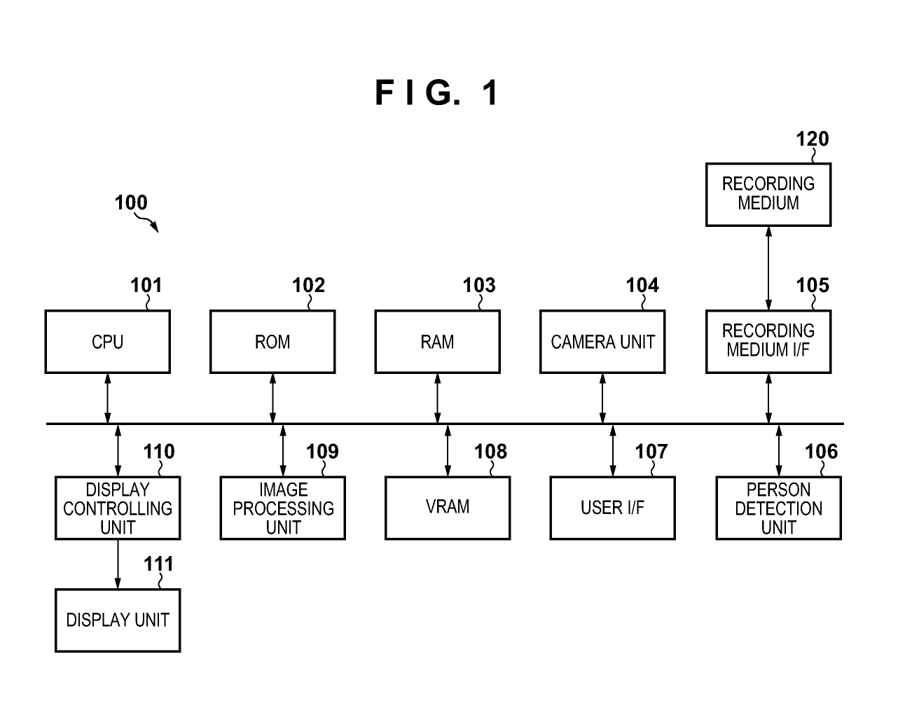

FIG. 1 is a block diagram showing the functional arrangement of a digital camera 100 according to the embodiment of the present invention.

A CPU 101 controls the operation of each block of the digital camera 100. More specifically, the CPU 101 controls the operation of each block by reading out the operation programs of representative image information generation processing and moving image list display processing (to be described later) that are stored in, for example, a ROM 102, extracting them in a RAM 103, and executing them.

The ROM 102 is, for example, a rewritable nonvolatile memory. The ROM 102 stores information such as parameters necessary for the operation of each block and the image capture settings of the digital camera 100, in addition to the operation programs of representative image information generation processing and moving image list display processing.

The RAM 103 is a volatile memory. The RAM 103 is used not only as an operation program extraction area, but also as an area for temporarily storing intermediate data output in the operation of each block.

In the embodiment, each block arranged as hardware in the digital camera 100 implements processing. However, the practice of the present invention is not limited to this, and processing of each block may be implemented by a program which performs the same processing as that of the block.

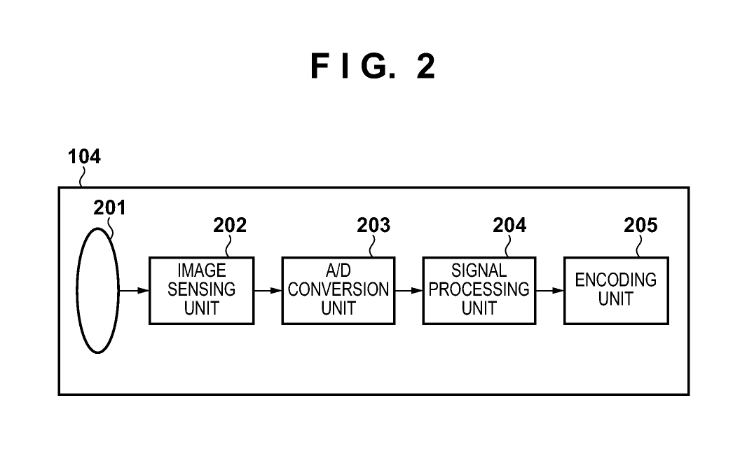

As shown in FIG. 2, a camera unit 104 is an image capturing unit including an imaging optical system 201, image sensing unit 202, A/D conversion unit 203, signal processing unit 204, and encoding unit 205. The camera unit 104 captures a subject, and outputs still image data or data of a frame of moving image data. The image sensing unit 202 is an image sensor such as a CCD sensor or CMOS sensor. The image sensing unit 202 photoelectrically converts an optical image formed on the image sensor via the imaging optical system 201, and outputs the obtained analog image signal to the A/D conversion unit 203. The A/D conversion unit 203 executes A/D conversion processing for the input analog image signal, and outputs the obtained digital image signal to the signal processing unit 204. The signal processing unit 204 is a signal processing circuit which performs processes such as correlated double sampling and gain control for an input digital image signal. The encoding unit 205 encodes, in a predetermined recording format, a digital image signal having undergone predetermined processing by the signal processing unit 204, and outputs still image data or image data representing a frame.

A person detection unit 106 performs an operation regarding creation of person detection information for image data of a frame output from the camera unit 104 or moving image data recorded on a recording medium 120 (to be described later). More specifically, the person detection unit 106 detects a person contained in each frame, and determines whether a pre-registered person exists in a frame. The person detection unit 106 creates person detection information representing a frame in which the pre-registered person has been detected, out of frames which form moving image data.

A user I/F 107 is an operation member arranged in the digital camera 100, including a power button and release button. When the user operates the operation member, the user I/F 107 outputs a control signal corresponding to the user operation to the CPU 101.

An image processing unit 109 applies various image processes such as color conversion processing and resize processing for still image data or image data representing a frame that has been output from the camera unit 104 or read out from the recording medium 120 (to be described later). In the embodiment, the image processing unit 109 generates a representative image (thumbnail image) from a frame output for moving image data.

A display unit 111 is a display device such as a compact LCD having a predetermined display area. The display unit 111 displays an image signal input from a display controlling unit 110. The display controlling unit 110 generates, from image data output from the camera unit 104 or image data or moving image data read out from the recording medium 120 (to be described later), an image signal to be displayed on the display unit 111. More specifically, the display controlling unit 110 extracts, in a VRAM 108, image data obtained from the camera unit 104 or recording medium 120. The display controlling unit 110 executes superimposition of GUI data read out from the ROM 102, D/A conversion processing, and the like, generating an image signal to be displayed in the display area of the display unit 111.

The recording medium 120 is a recording device such as a memory card or HDD which is detachably connected to the digital camera 100. The recording medium 120 records, via a recording medium I/F 105, image data or moving image data which is output from the camera unit 104 upon capturing a subject. In the embodiment, one or more moving image data are recorded on the recording medium 120. The data is read out via the recording medium I/F 105.

### <Representative Image Information Generation Processing>

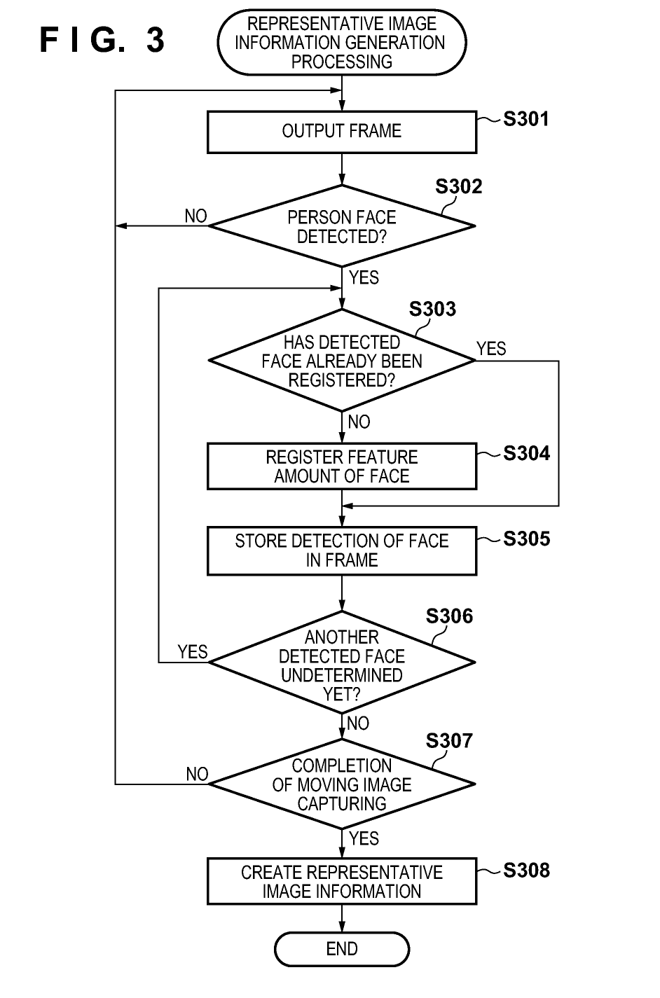

Representative image information generation processing by the digital camera 100 having the above arrangement according to the embodiment will be explained in detail with reference to the flowchart of FIG. 3. Representative image information is information of a frame (representative image generation frame) used to generate a representative image to be displayed on the display unit 111 when, for a pre-registered person, an instruction to display a representative image containing the face of the person is input in moving image list display processing (to be described later). Processing corresponding to this flowchart is implemented by, for example, reading out a corresponding processing program stored in the ROM 102, extracting it in the RAM 103, and executing it by the CPU 101. In the following description, representative image information generation processing starts when, for example, the CPU 101 determines, from a control signal output from the user I/F 107, that the user has input a moving image capture instruction while the digital camera 100 is set in the moving image capture mode.

In step S301, the CPU 101 controls the camera unit 104 to capture a subject and output the frame of moving image data. When the output frame is recorded as moving image data on the recording medium 120, the CPU 101 understands information about the ordinal number of the frame of the moving image data based on the execution count of this step. The information about the ordinal number of a frame is measured by, for example, initializing the value of an internal variable managed as a frame count to 0 at the start of representative image information generation processing, and incrementing it by one by the CPU 101 every time this step is executed.

In step S302, the CPU 101 controls the person detection unit 106 to determine whether the obtained frame contains the face of a person. Whether the face of a person is contained is determined using, for example, a face detection technique using wavelet transform and the image feature amount that is disclosed in Japanese Patent Laid-Open No. 2002-251380. If the person detection unit 106 determines that the obtained frame contains a person, the CPU 101 shifts the process to step S303. If the person detection unit 106 determines that the obtained frame does not contain a person, the CPU 101 returns the process to step S301, and executes processing for the next frame.

In step S303, the CPU 101 further controls the person detection unit 106 to determine whether one of faces detected in the obtained frame is the face of a pre-registered person. More specifically, the person detection unit 106 reads out the face image of a person registered in advance in the ROM 102 or information representing the feature amount of the face of the person, performs matching processing with the face detected in step S302, and transmits the result of the matching processing to the CPU 101. If the person detection unit 106 determines that the detected face is the face of a pre-registered person, the CPU 101 shifts the process to step S305. If the person detection unit 106 determines that the detected face is the face of an unregistered person, the CPU 101 shifts the process to step S304.

Moving image data assumes that the face of the same person is detected at close positions in continuous frames. Thus, for the once-detected face of a person, determination of whether he is a pre-registered person may be omitted by tracking the face position across frames.

When a plurality of faces are detected in a frame, it is determined whether each face is the face of a pre-registered person. Every time this step is executed, the CPU 101 selects, from a plurality of detected faces, a face for which it has not been determined whether the face is the face of a pre-registered person, and executes the following processes in steps S304 and S305.

In step S304, for a face determined in step S303 not to be the face of a pre-registered person, the CPU 101 registers information of the image or feature amount of the face in the ROM 102 together with an ID unique to the face (person). For the newly registered face information, for example, upon completion of capturing moving image data, the display unit 111 displays a notification to prompt the user to input a person name, and information of the person name input by the user is further registered in association with the face information.

In step S305, the CPU 101 adds information representing that the face determined in step S303 to be the face of the pre-registered person, or the newly registered face has been detected in the obtained frame. Then, the CPU 101 stores the information in the RAM 103 in association with the person ID of the face (person).

In step S306, the CPU 101 determines whether a face for which it has not been determined whether the face is the face of a pre-registered person still remains among faces detected in the obtained frame. If the CPU 101 determines that there is a face for which it has not been determined whether the face is the face of a pre-registered person, it returns the process to step S303 to make the determination for this face. If the CPU 101 determines that the determination is completed for all faces, it shifts the process to step S307.

In step S307, the CPU 101 determines whether moving image capturing is completed. More specifically, the CPU 101 determines, from a control signal output from the user I/F 107, that the user has input a moving image capture completion instruction. If the CPU 101 determines that moving image capturing is completed, it shifts the process to step S308. If the CPU 101 determines that moving image capturing continues, it returns the process to step S301.

By performing the processes in steps S303 to S306, the CPU 101 determines, for each frame, whether each face detected in the frame is the face of a pre-registered face. Then, the CPU 101 creates, in the RAM 103, person detection information representing information of a frame in which a predetermined face is detected in captured moving image data.

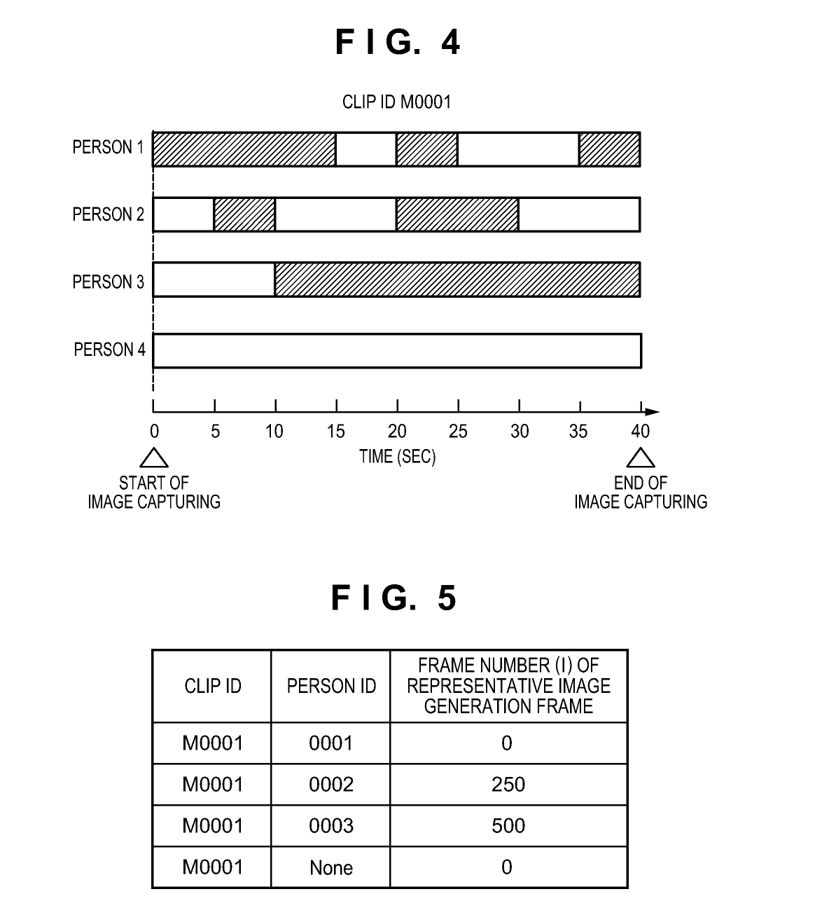

The person detection information is, for example, information representing whether each registered person has been detected in each frame of moving image data, as shown in FIG. 4. In the example of FIG. 4, four persons 1 to 4 are registered in advance. Frames in which the faces of the respective persons have been detected are indicated by hatching in 40-sec moving image data. For example, for person 1, it can be obtained from person detection information that the face has been detected in a frame of 0 sec to 15 sec and a frame of 20 sec to 25 sec in moving image data.

In step S308, the CPU 101 creates representative image information from the person detection information stored in the RAM 103, completing the representative image information generation processing. In the representative image information, for each moving image data, the person ID of each person detected in the moving image data and the frame number of a representative image generation frame for the detected person are associated with a clip ID (for example, M0001) serving as identification information of the moving image data. The representative image information suffices to be a table as shown in FIG. 5. FIG. 5 shows representative image information when person detection information is one in FIG. 4 and the moving image has 50 frames per sec. Note that a person ID “None” represents information of a representative image displayed for a person not detected in the moving image data in the following moving image list screen display processing in a state in which an instruction to display a representative image containing the face of the person is input, or in the default state.

The CPU 101 suffices to determine a representative image generation frame for each moving image data based on, for example, the following rules:
1) A representative image generation frame for a person detected in moving image data is a frame in which the person has been detected for the first time.
2) A representative image generation frame for a person not detected in moving image data, or a representative image generation frame in the default state is the first frame of the moving image data.

Note that the representative image generation frame determination method is not limited to this method. A representative image generation frame may be determined by an arbitrary method, such as a frame in which the maximum value of the evaluation value of a face has been detected, or a frame in which the result of separately executed facial expression detection processing indicates a specific facial expression. In the embodiment, representative image information contains even a representative image generation frame for a person not detected in moving image data or a representative image generation frame in the default state. However, the information does not depend on moving image data, and thus may not contain such a representative image generation frame.

In the embodiment, after creating representative image information, the CPU 101 controls the image processing unit 109 to generate each representative image based on the information using each representative image generation frame, and records the representative image on the recording medium 120 together with the representative image information in association with the moving image data. However, the practice of the present invention is not limited to this. For example, only representative image information may be recorded in association with moving image data without generating a representative image. Alternatively, only person detection information may be recorded in association with moving image data without generating representative image information. In this case, for example, when displaying an image list screen or when the user inputs a representative image display instruction, the CPU 101 may read out the representative image information or person detection information recorded in association with moving image data, extract a frame satisfying a condition from the moving image data, and control the image processing unit 109 to generate a representative image.

### <Moving Image List Display Processing>

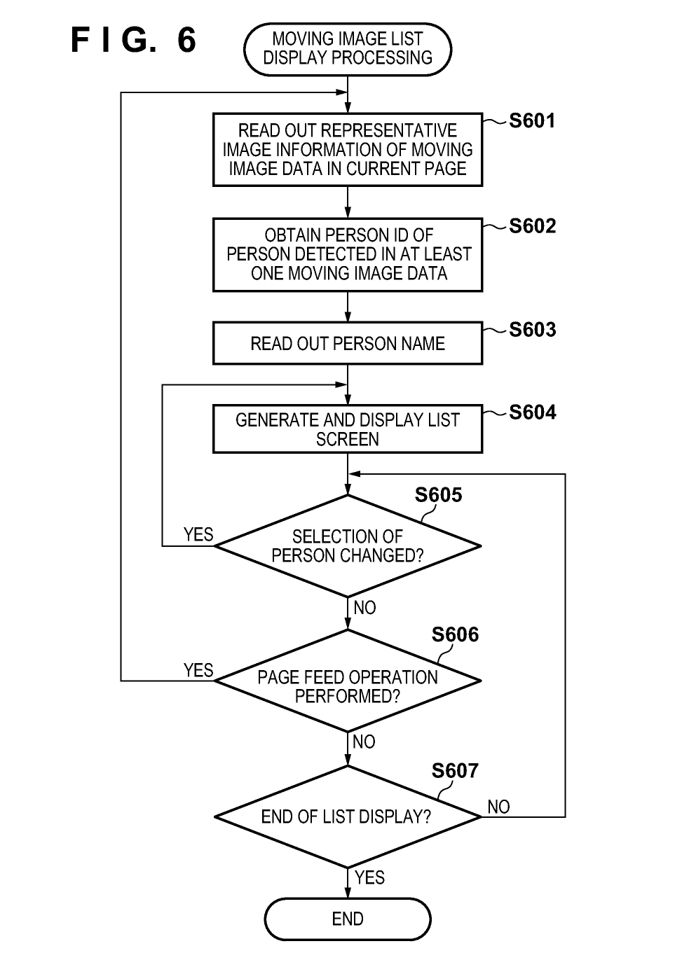

Moving image list display processing by the digital camera 100 according to the embodiment will be explained in detail with reference to the flowchart of FIG. 6. Processing corresponding to this flowchart is implemented by, for example, reading out a corresponding processing program stored in the ROM 102, extracting it in the RAM 103, and executing it by the CPU 101.

In the following description, moving image list display processing starts when, for example, the user switches the digital camera 100 to a mode in which a list of moving image data recorded on the recording medium 120 is displayed. In the embodiment, one list screen displays the representative images of 12 moving image data out of moving image data recorded on the recording medium 120 in the mode in which a list of moving image data is displayed. In the embodiment, one unit of a screen which displays a list of 12 moving image data is defined as a page. In response to an operation of switching the page by the user, the display unit 111 sequentially displays the representative images of 12 different moving image data. Note that information representing 12 moving image data contained in the currently displayed page is stored in the RAM 103 as, for example, internal information in the list display. Information representing 12 moving image data contained in the current page contains 12 clip IDs, and may be information which is changed in accordance with the page switching operation by the user.

In step S601, the CPU 101 reads out pieces of representative image information associated with moving image data whose representative images are contained in a page displayed on the display unit 111, that is, 12 moving image data contained in an arbitrary page. More specifically, the CPU 101 reads out information of moving image data contained in the current page from the RAM 103, and reads out pieces of representative image information associated with moving image data of all clip IDs contained in the information.

In step S602, the CPU 101 obtains information of a person detected in at least one of moving image data contained in the current page. More specifically, the CPU 101 obtains information of person IDs contained in the pieces of representative image information of respective moving image data contained in the current page that have been read out in step S601. Then, the CPU 101 merges overlapping person IDs out of the person IDs obtained from the pieces of representative image information of the respective moving image data, and obtains information of a person detected in at least one of the moving image data contained in the current page.

In step S603, the CPU 101 reads out, from the ROM 102, information of person names corresponding to the respective person IDs each indicating a person detected in at least one of the moving image data contained in the current page. Information of the person name is character string information displayed on the display unit 111 as a choice for a selectable person when displaying a representative image for a specific person in a list display screen (to be described later).

In step S604, the CPU 101 displays a list display screen regarding the current page on the display unit 111. More specifically, the CPU 101 reads out representative image data based on the current settings from the recording medium 120 for the respective moving image data contained in the current page, outputs them to the VRAM 108, and controls the display controlling unit 110 to generate a list screen in which the representative images are arranged. That is, according to the above-described rule 2), when the list screen is in the default state, 12 representative images generated from the first frames of 12 respective moving image data corresponding to the currently displayed page are displayed. The CPU 101 outputs character string information of the person names obtained in step S603 to the display controlling unit 110, generates a GUI representing the person names in accordance with the character string information, and superimposes the GUI as choices for a selectable person on the list screen generated in the VRAM 108. The CPU 101 controls the display controlling unit 110 to output the list screen generated in the VRAM 108 to the display unit 111, displaying the list screen.

Note that the representative images displayed on the list screen are changed in accordance with the selection state of the aforementioned choice for the selectable person. In the embodiment, the person name of a person detected in at least one of moving image data contained in the current page is displayed as a choice of whether to generate a representative image generated from a frame containing the person. More specifically, the user selects an arbitrary person as a choice on the list screen of moving image data. When the person is detected from moving image data, the digital camera 100 according to the embodiment can replace the currently displayed representative image of the moving image data with a representative image generated from a frame in which the person has been detected.

When a person is selected by a user operation, the CPU 101 stores information of the person ID of the selected person in the RAM 103. By using representative image information of each moving image data, the CPU 101 specifies moving image data in which a representative image generation frame is set for the person ID of the selected person. The CPU 101 obtains, from the recording medium 120, a representative image generated from a representative image generation frame for the specified moving image data, and outputs it to the VRAM 108 in place of the currently output representative image. For moving image data in which no representative image generation frame is set for the person ID of the selected person, the CPU 101 obtains, from the recording medium 120, a representative image generated from a representative image generation frame corresponding to the person ID “None”, and outputs it to the VRAM 108. In initial display in the default state, that is, in a state in which no person is selected, the representative images of all moving image data contained in the current page are representative images generated from representative image generation frames corresponding to the person ID “None”.

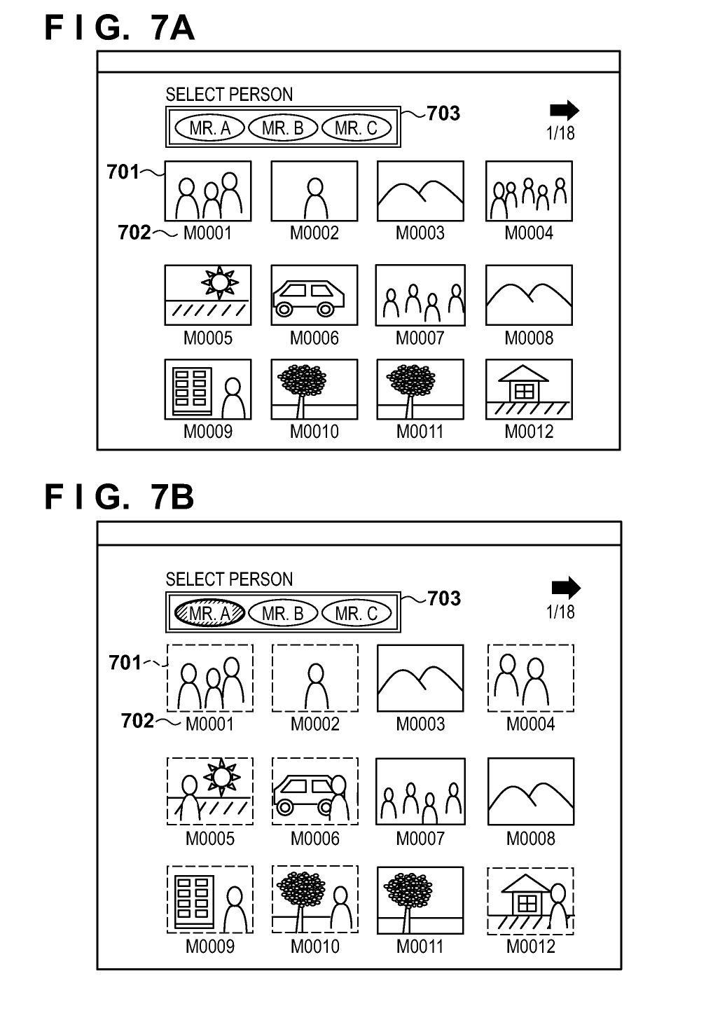

FIG. 7A exemplifies a list display screen displayed on the display unit 111 in the default state. As shown in FIG. 7A, the page includes a representative image 701 and clip ID 702 (which may be a file name or the like) for each of 12 moving image data. The page includes choices 703 for persons (for example, Mr. A, Mr. B, and Mr. C) at the upper left portion of the screen. When “Mr. A” is selected from the choices, the list screen changes to a screen in FIG. 7B by the above-described processing. In the example of FIG. 7B, moving image data having clip IDs of M0001, M0002, M0004, M0005, M0006, M0009, M0010, and M0012 contain frames in which “Mr. A” has been detected. The representative images of these moving image data have been changed. Some representative image generation frames are identical between the default state and the state in which “Mr. A” has been selected. Hence, as shown in FIG. 7B, moving image data containing “Mr. A” may be highlighted by superimposing a colored frame or blinking the moving image data to notify the user that the selected state is reflected. In FIG. 7B, the choice “Mr. A” is selected from the choices 703, so this choice is highlighted to be discriminable.

In step S605, the CPU 101 determines whether the selection state of the choice for the selectable person has been changed. More specifically, the CPU 101 determines whether information representing that the user has changed the selection state of the choice for the person has been received from the user I/F 107. If the CPU 101 determines that the selection state of the choice for the person has been changed, it returns the process to step S604. If the CPU 101 determines that the selection state of the choice for the person has not been changed, it shifts the process to step S606. When the CPU 101 receives information representing that the user has changed the selection state of the choice for the person, it changes, in accordance with the information, information of the person ID of the selected person that is stored in the RAM 103.

In step S606, the CPU 101 determines whether the user has performed a page feed operation. More specifically, the CPU 101 determines whether information representing that the user has performed a page feed operation has been received from the user I/F 107. If the CPU 101 determines that the user has performed a page feed operation, it returns the process to step S601. If the CPU 101 determines that the user has not performed a page feed operation, it shifts the process to step S607.

In step S607, the CPU 101 determines whether the user has performed an operation to end display of the list screen. More specifically, the CPU 101 determines whether information representing that the user has performed an operation to end display of the list screen has been received from the user I/F 107. If the CPU 101 determines that the user has performed an operation to end display of the list screen, it completes moving image list display processing. If the CPU 101 determines that the user has not performed the operation, it returns the process to step S605.

By this processing, when a person designated by the user is contained in moving image data, the representative image of moving image data can be changed from a default representative image to a representative image generated from a frame containing the designated person. The user can quickly detect moving image data containing the person of the user's choice.

In the embodiment, processing is executed for each page which displays a list of moving images. However, when the present invention is practiced in a display controlling apparatus such as a PC which can satisfactorily ensure a processing resource, the processing may be performed not for one page but for all moving image data recorded on a recording medium. That is, persons detected in all moving image data may be set as choices, and the representative images of all moving image data may be controlled in accordance with selection of a choice.

In the embodiment, only one person is selected from choices for persons for changing a representative image to a person-containing frame. However, the practice of the present invention is not limited to this, and a plurality of persons may be selected. For example, when the above-described person detection information is recorded on a recording medium in association with moving image data, the CPU 101 may specify a frame containing all selected persons, generate a representative image, and display it in place of a representative image currently displayed on the list screen.

In the embodiment, person detection is executed during capturing of moving image data to create person detection information and representative image information. Alternatively, person detection may be performed for already-recorded moving image data to generate person detection information and representative image information.

In the embodiment, when the user selects at least one person from a plurality of persons, a currently displayed representative image is replaced with a representative image generated from a frame containing the selected person, and then the list is displayed. After that, if the user selects another person, the previously selected person is canceled, the currently displayed representative image is further replaced with a representative image generated from a frame containing the newly selected person, and then the list is displayed.

In the embodiment, when the user selects at least one person from a plurality of persons and performs a predetermined operation such as an operation of selecting the same person again, the selection state of the person is canceled, the currently displayed representative image is replaced with a default representative image, and the list is displayed in the initial state.

In the embodiment, a person has been explained as an example of an object contained in a frame of moving image data. However, the type of object is not limited to this, and the present invention can be similarly implemented for another subject such as an animal, plant, or building.

In the embodiment, the condition to extract a frame for generating a representative image is that an object selected by the user is detected. However, a frame for generating a representative image may be extracted based on attribute information of a frame useful when the user searches for moving image data, such as the image capture time, image capture mode, image capture condition, or color information of a frame.

In the embodiment, when it is determined in step S606 that the user has performed a page feed operation, if a person selected in a previous page is also detected in 12 new moving image data, the 12 new moving image data may be displayed while the choice of the person remains selected. For moving image data containing a frame in which the person has been detected, out of the 12 new moving image data, a representative image generated from the frame in which the person has been detected may be displayed from the beginning. For moving image data not containing a frame in which the person has been detected, a preset representative image may be displayed.

As described above, the display controlling apparatus according to the embodiment can display a list from which the user can easily specify moving image data capturing a person of the user's choice. More specifically, the display controlling apparatus displays a list using representative images set in advance for moving image data. When the user selects a predetermined object and a frame containing the predetermined object exists in moving image data, the display controlling apparatus displays the list using a representative image generated from the frame containing the predetermined object, in place of the preset (default) representative image.

By only seeing representative images displayed in the list, the user can specify moving image data containing a person of the user's choice. The time taken to select and play back moving image data of the user's choice can be shortened.

### OTHER EMBODIMENTS

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefits of Japanese Patent Application No. 2011-177250, filed Aug. 12, 2011, and Japanese Patent Application No. 2012-155883, filed Jul. 11, 2012, which are hereby incorporated by reference herein in their entirety.

What is claimed is:

1. A display controlling apparatus comprising:
an obtaining unit configured to obtain moving image data;
a display controlling unit configured to display, on a screen, a representative image set in advance for moving image data obtained by said obtaining unit;
a determination unit configured to determine whether a frame satisfying predetermined conditions exists in the moving image data; and
a selection unit configured to select at least one of the predetermined conditions in response to a user operation,
wherein when said selection unit selects the predetermined condition, said display controlling unit displays a representative image generated from a frame satisfying the selected predetermined condition, in place of the representative image set in advance for the moving image data.

2. The apparatus according to claim 1, wherein
the predetermined condition is that a predetermined object is detected from a frame of the moving image data, and
said selection unit selects at least one of a plurality of predetermined objects.

3. The apparatus according to claim 2, wherein said determination unit determines whether a frame satisfying the predetermined condition exists, by referring to information of a frame contained in the moving image data in which each of the predetermined objects has been detected.

4. The apparatus according to claim 2, further comprising:
an output unit configured to capture a subject and output a frame of moving image data;
a detection unit configured to detect a predetermined object from the frame output from said output unit; and
a storage unit configured to store, in association with the frame, information for uniquely specifying the detected predetermined object.

5. The apparatus according to claim 1, wherein when said selection unit selects the predetermined condition, said determination unit determines whether a frame satisfying the predetermined condition exists in moving image data whose representative image is displayed on the screen.

6. The apparatus according to claim 1, wherein when displaying a representative image generated from a frame satisfying the predetermined condition, in place of the representative image, said display controlling unit displays the replacing representative image to be discriminable.

7. The apparatus according to claim 6, wherein the discriminable display is performed by superimposing a colored frame on the representative image generated from the frame satisfying the predetermined condition, or blinking the representative image generated from the frame satisfying the predetermined condition.

8. A method of controlling a display controlling apparatus, comprising:
an obtaining step of obtaining moving image data;
a display controlling step of displaying, on a screen, a list of representative images set in advance for moving image data obtained in the obtaining step;
a determination step of determining whether a frame satisfying predetermined conditions exists in the moving image data; and
a selection step of selecting at least one of the predetermined conditions in response to a user operation,
wherein in the display controlling step, when the predetermined condition is selected in the selection step, a list of representative images set in advance for the moving image data is displayed using images generated from frames satisfying the selected predetermined condition.

9. A computer-readable recording medium recording a program for causing a computer to function as each unit of a display controlling apparatus defined in claim 1.
